(19) United States
(12) Patent Application Publication
(10) Pub. No.: US 2012/0234766 A1
(43) Pub. Date: Sep. 20, 2012

(54) METHOD OF REMOVING ACIDS FROM COMPOSITIONS COMPRISING IONIC LIQUIDS

(75) Inventors: Michael SIEMER, Mannheim (DE); Sabine Schlautmann, Ludwigshafen (DE); Gabriele Iffland, Heidelberg (DE)

(73) Assignee: BASF SE, Ludwigshafen (DE)

(21) Appl. No.: 13/418,563

(22) Filed: Mar. 13, 2012

Related U.S. Application Data
(60) Provisional application No. 61/452,651, filed on Mar. 15, 2011.

(51) Int. Cl. B01D 15/04

(52) U.S. Cl. 210/681

(57) ABSTRACT

Method of separating acids from liquid compositions using a weakly basic ion exchanger, wherein
the compositions comprise salts of an organic cation and an anion and the concentration of these salts in the composition is at least 1% by weight.

The present application incorporates the provisional U.S. application 61/452,651 filed on Mar. 15, 2011 by reference.

The invention relates to a method of separating acids from liquid compositions using a weakly basic ion exchanger, wherein the compositions comprise salts of an organic cation and an anion and the concentration of these salts in the composition is at least 1% by weight.

Salts having an organic cation are, for example, of importance as ionic liquids. Ionic liquids have a melt point of less than 200° C., in particular less than 100° C.

There are a large number of industrial uses for ionic liquids, e.g. as solvents. During use, ionic liquids are generally not consumed but merely contaminated. Since they are high-priced salts, there is a need for particularly effective and advantageous methods of working up the mixtures obtained after use so that reuse is possible.

The use of ionic liquids for dissolving cellulose forms, for example, mixtures which in addition to the ionic liquid comprise solvents, in particular water, impurities introduced, e.g. degradation products of cellulose and of the ionic liquid. Degradation products of the ionic liquid are, in particular, acids which are formed from the anion of the ionic liquid.

To reuse the ionic liquid, there is a need for a simple and effective method of separating off these acids.

Ion exchangers for removing impurities and undesirable constituents are known. Ion exchangers and their uses are described, for example, in the review article “Ion-Exchange Polymers” in Encyclopedia Of Polymer Science And Engineering, Volume 8, pages 341 to 393, John Wiley & Sons, 1987. Among anion exchangers, a distinction is made between strongly and weakly basic anion exchangers. Strongly basic anion exchangers comprise quaternary ammonium groups; these can exchange their counteranion. Weakly basic ion exchangers, on the other hand, are ones which comprise a polymer having primary, secondary or tertiary amino groups as ion-exchange polymer and are thus able to bind acids. Here, the acid proton becomes attached to the amino group (quaternization) and the acid anion is bound as counteranion. A customary weakly basic ion-exchange resin is, for example, an acrylic-divinylbenzene copolymer having tertiary amino groups, which is obtainable from Lanxess under the trade name Lewatit® VP OC 1072 and is, according to the product information, recommended for the demineralization of water and the removal of organics from surface waters.

Ion exchangers are used in the preparation of ionic liquids. Accordingly, WO 2005/097730, for example, describes replacement of the anion using an ion exchanger in order to obtain the desired ionic liquid.

It is an object of the present invention to provide a simple and effective method of separating acids from compositions which comprise ionic liquids.

We have accordingly found the method defined at the outset.

In the method of the invention, acids are separated off from compositions which comprise salts of an organic cation and an anion.

### The Salts

In a preferred embodiment, the salts are salts which at atmospheric pressure (1 bar) have a melting point of less than 200° C., preferably less than 150° C., particularly preferably less than 100° C., and are therefore referred to as ionic liquids. In particular, the salts are liquid at 21° C., 1 bar.

The liquid compositions comprise salts of an organic cation and an anion.

Suitable organic cations are, in particular, organic compounds having heteroatoms such as nitrogen, sulfur, oxygen or phosphorus.

In particular, the organic cations are compounds having an ammonium group (ammonium cations), an oxonium group (oxonium cations), a sulfonium group (sulfonium cations) or a phosphonium group (phosphonium cations).

Preference is given to an organic cation having at least one nitrogen atom.

In a particular embodiment, the organic cations are ammonium cations, which for the present purposes are

nonaromatic compounds having a localized positive charge on the nitrogen atom, e.g.
compounds having tetravalent nitrogen (quaternary ammonium compounds) or compounds having trivalent nitrogen in which one bond is a double bond or
aromatic compounds having a delocalized positive charge and at least one nitrogen atom, preferably from 1 to 3 nitrogen atoms, in the aromatic ring system.

Preferred organic cations are quaternary ammonium cations, preferably ones having three or four aliphatic substituents, particularly preferably C1-C12-alkyl groups, which may optionally be substituted by hydroxyl groups, on the nitrogen atom.

Preference is likewise given to organic cations which comprise a heterocyclic ring system in which at least one nitrogen atom, preferably from 1 to 3 nitrogen atoms, is/are constituent of the ring system.

Monocyclic, bicyclic, aromatic or nonaromatic ring systems are possible. Mention may be made by way of example of bicyclic systems as are described in WO 2008/043837. The bicyclic systems of WO 2008/043837 are diazabicyclo derivatives, preferably made up of a 7-membered ring and a 6-membered ring, which comprise an amidinium group; mention may be made, in particular, of the 1,8-diazabicyclo[5.4.0]undec-7-enium cation.

Very particular preference is given to cations which comprise a heterocyclic ring system having one or two nitrogen atoms as constituent of the ring system.

Possible organic cations of this type are, for example, pyridinium cations, pyridazinium cations, pyrimidinium cations, pyrazinium cations, imidazolium cations, pyrazolium cations, pyrazolinium cations, imidazolinium cations, thiazolium cations, triazolium cations, pyrrolidinium cations and imidazolidinium cations. These cations are described, for example, in WO 2005/113702. If it is necessary for a positive charge on the nitrogen atom or in the aromatic ring system, the nitrogen atoms are each substituted by a hydrogen atom or an organic group having generally not more than 20 carbon atoms, preferably a hydrocarbon group, in particular a C1-C16-alkyl group, in particular a C1-C10-, particularly preferably a C1-C4-alkyl group.

The carbon atoms of the ring system can also be substituted by organic groups having generally not more than 20 carbon atoms, preferably a hydrocarbon group, in particular a C1-C16-alkyl group, in particular a C1-C10-, particularly preferably a C1-C4-alkyl group.

Particularly preferred ammonium cations are quaternary ammonium cations, imidazolium cations, pyrimidinium cations and pyrazolium cations.

The organic cation is particularly preferably an imidazolium cation of the formula I

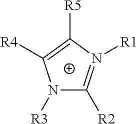

where

R1 is an organic radical having from 1 to 20 carbon atoms and

R2, R3, R4 and R5 are each an H atom or an organic radical having from 1 to 20 carbon atoms.

In formula I, preference is given to R1 and R3 each being, independently of one another, an organic radical having from 1 to 10 carbon atoms. In particular, R1 and R3 are each an aliphatic radical, in particular an aliphatic radical without further heteroatoms, e.g. an alkyl group. Particular preference is given to R1 and R3 each being, independently of one another, a C1-C10- or C1-C4-alkyl group.

In formula I, preference is given to R2, R4 and R5 each being, independently of one another, an H atom or an organic radical having from 1 to 10 carbon atoms; in particular R2, R4 and R5 are each an H atom or an aliphatic radical. Particular preference is given to R2, R4 and R5 each being, independently of one another, an H atom or an alkyl group; in particular, R2, R4 and R5 are each, independently of one another, an H atom or a C1-C4-alkyl group. Very particular preference is given to R2, R4 and R5 each being an H atom.

The anion associated with the organic cation can be any anion.

Possible anions are, in particular, the customary anions of ionic liquids; mention may be made by way of example of Cl⁻, Br, BF₄⁻, H₃C—COO⁻, HCOO⁻, H₃C—O—SO₃⁻, H₃C—SO₃⁻, F₃C—O—SO₃⁻, PF₆⁻, CH₃—CH₂—COO⁻SCN⁻, SO₃²⁻, NO₃⁻, ClO4⁻.

The anions of the salts are preferably carboxylates.

As such carboxylates, mention may be made, in particular, of organic compounds having from 1 to 20 carbon atoms and comprising one or two carboxylate groups, preferably one carboxylate group.

The carboxylates can be either aliphatic or aromatic carboxylates; for the purposes of the present invention, aromatic carboxylates are carboxylates comprising aromatic groups. Particular preference is given to aliphatic or aromatic carboxylates which, apart from the oxygen atoms of the carboxylate group, comprise no further heteroatoms or at most one or two hydroxyl groups, carbonyl groups or ether groups. Examples of the latter are hydroxycarboxylates or ketocarboxylates.

As carboxylates having such further heteroatoms, mention may be made by way of example of the carboxylates of glycolic acid, furandicarboxylic acid, levulinic acid (4-oxopentanoic acid).

Particular preference is given to aliphatic or aromatic carboxylates which, apart from the oxygen atoms of the carboxylate group, comprise no further heteroatoms, e.g. the carboxylates of alkanecarboxylic acids, alkenecarboxylic acids, alkynecarboxylic acids, alkadienecarboxylic acids, alkatrienecarboxylic acids, benzoic acid or phenylacetic acid. Suitable carboxylates of alkanecarboxylic acids, alkenecarboxylic acids and alkadienecarboxylic acids are also known as fatty acid carboxylates.

Very particular preference is given to C1-C20-alkanoates (carboxylates of alkanecarboxylic acids), in particular C1-C16-alkanoates. Particular mention may be made of the carboxylates of formic acid (C1-carboxylic acid), acetic acid (C2-carboxylic acid), propionic acid (C3-carboxylic acid), n-butyric acid (C4-carboxylic acid), n-valeric acid (C5-carboxylic acid), n-caproic acid (C6-carboxylic acid), n-caprylic acid (C8-carboxylic acid), octanoic acid), n-capric acid (C10-carboxylic acid, decanoic acid), lauric acid (C12-carboxylic acid, dodecanoic acid), palmitic acid (C16-carboxylic acid), hexadecanoic acid) or stearic acid (C18-carboxylic acid). In a preferred embodiment, the anions of the salts are carboxylates of C6-C12-alkanecarboxylic acids (i.e. C6-C12-alkanoates).

Examples of salts of the organic cation and the anion are:
1-ethyl-3-methylimidazolium acetate,
1-methyl-3-methylimidazolium acetate,
1-ethyl-3-ethylimidazolium acetate,
1-ethyl-3-methylimidazolium octanoate,
1-methyl-3-methylimidazolium octanoate,
1-ethyl-3-ethylimidazolium octanoate.

The composition can comprise only one salt of an organic cation and an anion or a mixture of such salts. The information given in the present patent application also applies to the mixtures. For example, the composition can comprise salts having different cations, in particular differently substituted imidazolium cations of the formula I, or different anions, in particular different carboxylates, e.g. acetate and octanoate. The terms salt or ionic liquid also refer in the following to mixtures of such salts or ionic liquids.

The content of the above-defined salts or the preferred salts in the composition is preferably at least 5% by weight, in particular at least 10% by weight, particularly preferably least 20% by weight and very particularly preferably at least 30% by weight. In a particularly preferred embodiment, the content of the salts in the composition can be at least 40% by weight and in particular at least 50% by weight. However, the content of the salts is generally not more than 98% by weight, in particular not more than 95% by weight and preferably not more than 90% by weight. All weights indicated are based on the total composition.

### The Acids

The acids to be separated off from the composition are hydrogen acids and preferably have a pKₐ of greater than 2, preferably greater than 3, particularly preferably greater than 4.

The pKₐ of the acids is preferably from 2 to 15, preferably from 3 to 15, in particular from 3 to 8 and particularly preferably from 4 to 6.

The pKₐ is the negative logarithm to the base ten of the acid constant, KA.

The pKₐ is for this purpose measured at 25° C., 1 bar in water or dimethyl sulfoxide as solvent. It is therefore sufficient for the acid to have the appropriate pKₐ either in water or in dimethyl sulfoxide. The pKₐ is preferably measured in water. Dimethyl sulfoxide is used particularly when the anion is not sufficiently soluble in water. References to both solvents may be found in standard reference works.

Particular mention may be made of carboxylic acids as acids having an appropriate pKₐ.

As such carboxylic acids, particular mention may be made of organic compounds having from 1 to 20 carbon atoms and comprising one or two carboxylic acid groups, preferably one carboxylic acid group.

The carboxylic acids can be either aliphatic or aromatic carboxylic acids; for the purposes of the present invention, aromatic carboxylic acids are ones which comprise aromatic groups. Particular preference is given to aliphatic or aromatic carboxylic acids which, apart from the oxygen atoms of the carboxylic acid group, comprise no further heteroatoms or comprise at most one or two hydroxyl groups, carbonyl groups or ether groups. Examples of the latter are hydroxycarboxylic acids or ketocarboxylic acids.

As carboxylic acids having such further heteroatoms, mention may be made by way of example of glycolic acid, furandicarboxylic acid, levulinic acid (4-oxopentanoic acid).

Particular preference is given to aliphatic or aromatic carboxylic acids which, apart from the oxygen atoms of the carboxylic acid group, comprise no further heteroatoms, e.g. alkanecarboxylic acids, alkenecarboxylic acids, alkynecarboxylic acids, alkadienecarboxylic acids, alkatrienecarboxylic acids, benzoic acid or phenylacetic acid. Suitable alkanecarboxylic acids, alkenecarboxylic acids and alkadienecarboxylic acids are also known as fatty acids.

Very particular preference is given to C1-C20-alkanecarboxylic acids, in particular C1-C16-alkanecarboxylic acids. Particular mention may be made of formic acid (C1-carboxylic acid), acetic acid (C2-carboxylic acid), propionic acid (C3-carboxylic acid), n-butyric acid (C4-carboxylic acid), n-valeric acid (C5-carboxylic acid), n-caproic acid (C6-carboxylic acid), n-caprylic acid (C8-carboxylic acid, octanoic acid), n-capric acid (C10-carboxylic acid, decanoic acid), lauric acid (C12-carboxylic acid, dodecanoic acid), palmitic acid (C16-carboxylic acid, hexadecanoic acid) or stearic acid (C18-carboxylic acid). In a particular embodiment, the acids are C6-C12-alkanecarboxylic acids.

In a preferred embodiment, more than 30% by weight, in particular more than 50% by weight, of the acids to be separated off are C1-C20-alkanecarboxylic acids.

The acids can have got into the composition in different ways. They can have been formed from the anions of the salts or can be degradation products of compounds with which the ionic liquid has come into contact in a prior use, e.g. they can be degradation products of cellulose when the ionic liquid has previously been used as solvent for cellulose. In a preferred embodiment, at least part of the acids to be separated off are acids which have been formed from the anions of the above salts. In particular, at least 30% by weight of the acids are acids which have been formed from the anions of the salts.

### The Further Constituents of the Compositions

The compositions are, in particular, compositions which are obtained during or after use of ionic liquids or after a work-up or purification (for the purposes of reuse of ionic liquids) following the use of the ionic liquids.

Ionic liquids are of importance for many industrial applications. They can, for example, be used as solvent, electrolyte or working liquid, including, for example, hydraulic fluids, lubricants, absorption media in cyclic processes, damping liquids or force transmission media.

For these purposes, ionic liquids can optionally be used in combination with nonionic solvents. Possible nonionic solvents are, for example, ones which mix homogeneously with the ionic liquid in the desired mixing ratio. Mention may be made by way of example of water, acetone, dioxane, dimethyl sulfoxide, dimethylacetamide, formamide, N-methylmorpholine N-oxide or dichloromethane. Particular preference is given to water as nonionic solvent. Such nonionic solvents, in particular, can therefore also be constituents of the composition for the purposes of the present invention.

The composition preferably comprises predominantly ionic liquid or a mixture of ionic liquid with a nonionic solvent, preferably water. Suitable mixtures of the ionic liquid with a nonionic solvent can comprise, for example,

from 5 to 95% by weight of nonionic solvent and
from 5 to 95% by weight of ionic liquid.

In particular, they can comprise

from 20 to 95% by weight of nonionic solvent and
from 5 to 80% by weight of ionic liquid.

In a particular embodiment, they can comprise

from 60 to 90% by weight of nonionic solvent and
from 10 to 40% by weight of ionic liquid.

The above percentages are based on the total weight of ionic liquid and nonionic solvent.

The composition preferably comprises more than 80% by weight, in particular more than 90% by weight or more than 95% by weight, of ionic liquid or a mixture of ionic liquid with nonionic solvent, in particular water.

The content of the acids to be separated off is preferably from 0.05 to 20 parts by weight, in particular from 0.1 to 10 parts by weight or from 0.2 to 5 parts by weight, of acids per 100 parts by weight of the salts (ionic liquids) or mixtures thereof with a nonionic solvent.

The acid number of the compositions is preferably from 0.5 to 50 mg KOH/g of composition, in particular from 1 to 30 mg KOH/g (measured at 20° C.).

The composition used for the method of the invention is preferably liquid (at 21° C., 1 bar).

The compositions used for the purposes of the present invention can be compositions which are obtained after various industrial uses of ionic liquids or mixtures thereof with nonionic solvents or which are obtained after the prior use and a further work-up.

The ionic liquid or the mixture of ionic liquid and nonionic solvent can therefore comprise additives, starting materials or degradation products which are caused by a previous industrial use or work-up. Additives which may be mentioned are, for example, thickeners, stabilizers, corrosion inhibitors, antifoams, etc.

Industrial uses of the ionic liquid or the mixtures of ionic liquids with nonionic solvents are, for example, uses as solvent, as electrolyte, in particular as electrolyte for the production of aluminum or the coating of any substrates with aluminum (aluminum plating), or working liquid, including, for example, hydraulic fluids, lubricants, absorption media in cyclic processes, damping liquids or force transmission media.

A use of the ionic liquid as solvent for otherwise sparingly soluble or insoluble synthetic or natural polymers is particularly critical with a view to purification and reuse of the ionic liquid.

In this context, the use of an ionic liquid or a mixture thereof with nonionic solvents as solvent for polysaccharides and in particular for cellulose is of particular importance since cellulose films, cellulose beads or cellulose fibers can be produced from the resulting solutions, as is also described in WO 2003/029329, WO2009/062723 and WO2007/076979.

The term cellulose here refers to cellulose, hemicellulose, modified cellulose (cellulose esters or cellulose ethers) and mixtures thereof with lignin, in particular with less than 40 parts by weight of lignin per 100 parts by weight of cellulose.

In such uses, cellulose is particularly preferably used in the form of pulp.

To produce cellulose films, cellulose beads or cellulose fibers, the dissolved cellulose has to be precipitated from the solution by addition of a coagulant. Suitable coagulants are any compounds in which the cellulose does not dissolve, e.g. water or methanol, in particular water. The coagulant can naturally also be used in the form of a mixture with other solvents, e.g. the ionic liquid; such mixtures should, however, comprise the coagulant in sufficient amounts; suitable mixtures are, for example, mixtures of water and ionic liquid in a weight ratio of from 100 parts by weight of water to 0 part by weight of ionic liquid to 60 parts by weight of water to 40 parts by weight of ionic liquid. The coagulation is carried out in a known manner in such a way that the cellulose is obtained in the desired form, as film, beads or fibers, and is separated off in this form.

Suitable compositions for the method of the invention are compositions which are obtained after the above uses. The compositions obtained in the use can optionally be worked up before carrying out the method of the invention, e.g. solids can be separated off by filtration or solvents can be separated off by distillation.

In the case of a prior use of the ionic liquid for producing cellulose films, cellulose beads or cellulose fibers, the compositions can, for example, comprise residual cellulose which has not been separated off, including, as indicated above, hemicelluloses, or other materials which can be comprised in cellulose, in particular low molecular weight sugars such as monosaccharides, disaccharides or oligosaccharides or degradation products of these compounds. In the following, the term hemicelluloses encompasses all low molecular weight saccharides having a molecular weight of less than 500 g/mol. These are soluble in water.

Compositions which originate from a use of the ionic liquid as solvent for cellulose comprise, in particular, ionic liquid and nonionic solvent, in particular water, in the amounts indicated above; they comprise acids as indicated above, possibly from degradation of the anions of the ionic liquid and possibly from the degradation of the cellulose and they comprise hemicelluloses. Such a composition comprises, in particular, more than 80% by weight of ionic liquid and optionally a solvent miscible therewith, particularly preferably more than 80% by weight of a mixture of from 60 to 90% by weight of nonionic solvent (in particular water) and from 10 to 40% by weight of ionic liquid. In addition, such a composition comprises acids as indicated above and in particular from 0.1 to 5 parts by weight, particularly preferably from 0.2 to 5 parts by weight, of hemicellulose per 100 parts by weight of the total weight of ionic liquid and nonionic solvent.

The method of the invention for separating off acids is simple to carry out and very effective. In particular, it makes it possible to separate off acids at a very high salt content of the composition.

### EXAMPLES

### Example 1

### Materials:

A liquid mixture from cellulose processing was used as composition. Cellulose was dissolved in EMIM octanoate (1-ethyl-3-methylimidazolium octanoate), coagulated by addition of water and separated off.

The resulting composition comprised more than 95% by weight of a mixture of 20 parts by weight of EMIM octanoate and 80 parts by weight of water. The composition additionally comprised about 0.3 part by weight of hemicelluloses per 100 parts by weight of EMIM octanoate/water, about 50 mmol of acids per 1000 g of EMIM octanoate/water, about 1000 ppm of alkali metal cations and various anions such as chlorides and sulfates.

The acids were octanoic acid, acetic acid, formic acid and levulinic acid.

The acid number of the composition was 2.62 mg KOH/g and the pH was 7.6

Lewatit VP OC 1072 from Lanxess was used as ion-exchange resin. This is an acrylic-divinylbenzene copolymer having tertiary amino groups.

The ion-exchange resin was introduced into a column having a height of 100 cm and a diameter of 2 cm.

The bed volume (BV) of the ion-exchange resin introduced was 0.19 liter.

### Procedure

The ion exchange (loading) was carried out at room temperature (21° C.) and a throughput of the composition of 1000 ml/hour (h), corresponding to 5.2 BV/h (flow direction from the top downward). After the composition had passed through the ion exchanger, samples for determining the pH and acid number were taken.

The acid number of the composition dropped from the previous 2.62 to a value below 0.2 (fluctuations in the range from 0.14 to 0.18) after passage through the ion exchanger, and the pH rose from 7.6 to 10.2-10.5.

After about 5 hours (i.e. after a total throughput of the composition amounting to 38 times the BV), the acid number increased and the pH decreased. The ion exchanger was now fully loaded and its capacity exhausted (also referred to as breakthrough=point in time at which the capacity of the ion exchanger is exhausted).

The ion exchanger has, according to the manufacturer, a total capacity of not less than 1.5 eq/l.

In the experiments, a capacity of about 1.3 eq./l was achieved.

The ion exchanger was then washed free of product by means of deionized water (about 1 BV/h, total amount of water=about 5 BV) as preparation for regeneration. A 5% strength NaOH solution was used for regeneration. The alkali solution was passed from the top downward through the ion exchanger at about 5.2 BV/h. The ion exchanger was rinsed with deionized water before renewed loading.

The ion exchanger could then once again be used and regenerated as described above (cycles), with the same results being achieved.

The amount of alkali solution for regeneration was varied in the range 8-1 BV during the various cycles. An amount of 2 BV proved to be sufficient. The amount of deionized water was varied in the range 35-8 BV in the various cycles. An amount of 10 BV (10 times the bed volume) proved to be sufficient.

### Examples 2 to 5

A series of experiments with increasing concentration of ionic liquid in the composition was carried out. For this purpose, EEIM octanoate (1-ethyl-3-ethyl-imidazolium octanoate) comprising octanoic acid was diluted with water. The content of EEIM octanoate is shown in the table below. The balance is water.

The amount of Lewatit VP OC 1072 indicated in the table was in each case added to 100 g of the compositions and the mixture was shaken overnight (10 hours) at 40° C. in a shaking apparatus. As a result of the addition of water, the initial acid number of the composition was correspondingly lower and the amount of Lewatit VP OC 1072 used was matched thereto.

The acid number of the composition was determined before and after shaking.

| Content of EMIM | | | |
|---|---|---|---|
| octanoate in the | Acid number in | Amount of Lewatit | Acid number in |
| composition | KOH/g before | VP OC 1072 | mg KOH/g |
| % by weight | shaking | added in gram | after shaking |
| 17 | 2.6 | 1.9 | 0.8 |
| 38 | 5.6 | 3.8 | 2.1 |
| 58 | 7.6 | 5.7 | 4.1 |
| 78 | 10.2 | 7.8 | 8.8 |

1. A method of separating acids from liquid compositions using a weakly basic ion exchanger, wherein
the compositions comprise salts of an organic cation and an anion and the concentration of these salts in the composition is at least 1% by weight.

2. The method according to claim 1, wherein the salts are ionic liquids.

3. The method according to either claim 1 or 2, wherein the cation is an organic cation having at least one nitrogen atom.

4. The method according to any of claims 1 to 3, wherein the cation is an organic cation having a heterocyclic ring system and at least one nitrogen atom as constituent of the ring system.

5. The method according to any of claims 1 to 4, wherein the organic cation is an imidazolium cation of the formula I, 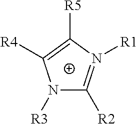
where
R1 is an organic radical having from 1 to 20 carbon atoms and
R2, R3, R4 and R5 are each an H atom or an organic radical having from 1 to 20 carbon atoms.

6. The method according to any of claims 1 to 5, wherein the salts are salts of an imidazolium cation of the formula I and a C1-C20-alkanoate as anion.

7. The method according to any of claims 1 to 6, wherein the concentration of the salts in the composition is at least 5% by weight.

8. The method according to any of claims 1 to 7, wherein the acids are acids having a pKₐ of greater than 2.

9. The method according to any of claims 1 to 8, wherein the acids to be separated off are carboxylic acids.

10. The method according to any of claims 1 to 9, wherein more than 30% by weight of the acids to be separated off are C1-C20-alkanecarboxylic acids.

11. The method according to any of claims 1 to 8, wherein the composition comprises more than 80 weight of ionic liquid and optionally a solvent which is miscible therewith and from 0.1 to 5 parts by weight of hemicellulose per 100 parts by weight of the total weight of ionic liquid and solvent.
